(19) United States
(12) Patent Application Publication
(10) Pub. No.: US 2007/0140121 A1
(43) Pub. Date: Jun. 21, 2007

(54) Method of preventing denial of service attacks in a network

(76) Inventors: Chris Bowman, Round Rock, TX (US); Frank Sheiness, Austin, TX (US); David W. Daugherty, Austin, TX (US)

Correspondence Address: ANTHONY EDW. J CAMPBELL, PO BOX 160370, AUSTIN, TX, 78716, US

(21) Appl. No.: 11/639,842

(22) Filed: Dec. 15, 2006

Related U.S. Application Data
(60) Provisional application No. 60/752,768, filed on Dec. 21, 2005.

(51) Int. Cl. H04L 12/26

(52) U.S. Cl. 370/230

(57) ABSTRACT

A system, method, and computer readable medium for preventing denial of service attacks in a network, comprising counting a data packet generated by an address on the network and blocking access to the network of the address if the counted data packets exceeds a pre-defined threshold. In other embodiments, the counting may per performed per time unit, the blocking may be active for a pre-set interval, the address may be disabled, the address may be a media access control address, the counting could be performed at layer 2 or layer 1, the address may be identified upon connection to the network, the threshold may be based upon a number of computers utilizing the network, the defined threshold may be based upon a bandwidth of the network and the disinfecting may be done of the address exceeding the pre-defined threshold.

### PRIORITY

This application is based upon provisional application 60/752,768, filed Dec. 12, 2005, and claims filing date priority based upon that application.

### BACKGROUND OF THE INVENTION

The present invention is generally related to a network security and, more specifically to a method of preventing denial of service attacks in a network.

A Denial of Service (DoS) brute force attack is on in which a computer connected to a network consumes large portions of the network bandwidth. Brute force attacks performed via computer virus infection on unknowing computers has risen to nearly crisis proportions. Currently, network security performs intrusion prevention and detection technology at the layer 3-4 level. These devices can stop data packets from exiting or entering a Local Area Network (LAN), but do nothing to stopped forced flooding of a LAN from within the network.

Therefore, what is needed is a method of preventing denial of service attacks in a network. More specifically, what is needed is a method of preventing denial of service attacks in a network that operates at layer 2. The present invention provides the ability to automatically detect, and then block a network connection from a malicious computer via layer 2 monitoring and access control list.

The present invention utilizes a computer program which monitors how many data packets per second are coming from each Media Access Control (MAC) address on the Local Area Network (LAN). If one MAC address exceeds a pre-determined threshold, in this instance of 2,000 data packets per second counted, then the computer program will automatically execute a layer 2 command which will cause an Address Resolution Protocol (ARP) request from the malicious computer to go unanswered for a pre-set time interval such as 10 minutes. During the computer will not be able to relocate its gateway, effectively blocking it from the network. There are no other known methods that can identify and isolate a denial of service attack at layer 2.

The current invention uses a pre-determined threshold of data packet transmission of 2000 data packets per second counted to identify and then isolate offending computers. Other embodiments of the invention may use the number of computers on the LAN, the total bandwidth on the LAN or Wide Area Network (WAN) and the type applications being used on the computer to set the threshold.

In the present invention the computer program identifies any new MAC addresses received via ARP. After each MAC address is identified another computer program calculates the number of data packets per second transferred by each MAC address. If a computer exceeds a preset threshold of 2000 data packets per second then the offending computers MAC address is blocked which in turn terminates all activity from the offending computer.

Advantages of controlling malicious computers at Layer 2 include the ability to control attacks from within the LAN, and the reduction of capital cost associated with the elimination of Layer 3 and higher network equipment required to prevent attacks from outside the network. Without this invention, one computer on a LAN could effectively consume the entire bandwidth of the LAN slowing all other computers to a crawl by of brute force network attacks or excessive port scanning.

The present invention is a virtual or Internet-based set-top box for the acquisition and management of Internet services and content delivered through the Internet. This system is comprised network appliances that are installed in the LAN infrastructure to assert controls necessary to establish and maintain consistent, standard Internet services for sites that have numerous Internet Service Providers (ISPs). The service management console is a web-based system that provides the end-user controls required to configure and control Internet services and content delivered to all sites. Each geographically remote site is configured with a network appliance and is managed by a web-resident, centralized control system that provides various levels of administrative service depending upon the administrator.

This system allows end users to select any combination of content, and communication services provided by service providers. These options will typically include bundled service packages (voice, data and video) and select communication service parameters like bandwidth, Internet Protocol (IP) addresses, and Voice over IP (VoIP).

The present invention utilizes a Media Access Control address (MAC) based means of controlling communications services within a Local Area Network (LAN). This system allows service providers to deploy internet services to end customer based on a MAC addresses collected by the system or provided by the customer. The system allows the service provider and customer access to network provision controls for a specific to a specific MAC address.

The present invention utilizes the MAC-based means of controlling LAN quality of service. This includes the ability to automatically detect various types of security threads based on data packet signature and the subsequent adjustment services. Adjustment can include the following automated or manual changes, termination of service, customer isolation or quarantining and the notification of management and technical personnel.

The present invention utilizes an internet-based means of identification and authenticating Internet service customers. This system includes the ability to identify customers by their computer MAC addresses, identification of communication appliances using appliance specific electronic identification information. This system is used to authenticate customers or communication appliances for the use of Internet-based communication services and/or access to Internet based content.

A MAC-based means of controlling network Denial of Service (DoS) attacks. From a technical perspective, problems arise when a user starts flooding any destination on the Internet; a flood could be a port scan, high rate of Internet Control Message Protocol (ICMP) or pings, User Datagram Protocol (UDP) floods. This system allows the service provider to define ICMP, UDP and Transmission Control Protocol (TCP) packet limits to control this type of traffic. Default ranges are typically set for UDP at 150 Packets Per Second (PPS), TCP at 200 PPS, and ICMP at 50 PPS.

This system provide the information to facilitate the identification and management and isolation of computers that begin making abnormal Internet service requests before they have an opportunity to impact LAN performance. The system restricts certain kinds of traffic based on predefined thresholds. In severe cases, the system will redirect compromised computers to a quarantine area where utilities are available for discovering and correcting the problem before restoring access to the Internet.

Currently, brute force attacks performed unknowingly due to computer virus infection has risen to nearly crisis proportions. This problem is particularly problematic for large enterprise networks like those found in college student housing. Recent attacks have degraded Internet access to the point where it has a negative impact on the financial performance of infected commercial properties.

Assuming the worker/network engineer can monitor Layer 2 switch ports, he/she would have to find out what switch port the offending computer resides on (switch or router) and then physically disconnect the wire or issue an instruction to the switch (on those switches with port level control) to disconnect the port electronically. In this invention offending computers are automatically identified and isolated by utilizing computer programs at the layer 2 level.

An alternative version of the invention utilizes counting data packets per second at the protocol level instead of layer 2, or a combination of both layer 1 and layer 2. This method would involve developing scripts to monitor popular protocols, UDP, TCP, and ICMP. We would put defined limits on each protocol, UDP, for example, might be limited to a maximum of 500data packets per second, TCP might be limited to 200data packets per second, and ICMP 50 data packets per second. This would provide more granular control over what should be blocked. If, for example, an offending computer was flooding the network with UDP traffic, we could shut down the UDP connections without affecting TCP and ICMP traffic. This invention provides a more consistent and safe network for computers residing on a LAN and automatically alerts network engineers about problem causing computers. Thus eliminates a time consuming, tedious task of locating and isolated problem computers.

In one embodiment of the present invention, a method for a method for preventing denial of service attacks in a network, comprising counting a data packet generated by an address on the network and blocking access to the network of the address if the counted data packets exceeds a pre-defined threshold. In other embodiments, the counting may per performed per time unit, the blocking may be active for a pre-set interval, the address may be disabled, the address may be a media access control address, the counting could be performed at layer 2 or layer 1, the address may be identified upon connection to the network, the threshold may be based upon a number of computers utilizing the network, the defined threshold may be based upon a bandwidth of the network and the disinfecting may be done of the address exceeding the pre-defined threshold.

In a further embodiment of the present invention, a computer readable medium comprising instructions for identifying a media access control address upon connection to a network, counting a data packet generated per unit time by the media access control address on the network and blocking access of the media access control address to the network if the counted data packets exceeds a pre-defined threshold. In other embodiments the blocking is active for a pre-set interval, the counting could be performed at layer 2 or layer 1. The invention may include instructions for disabling the media access control address, defining the threshold based upon the number of computers utilizing the network and the bandwidth of the network and disinfecting the media access control address exceeding the pre-defined threshold.

In yet a further embodiment, a system adapted to provide preventing denial of service attacks in a network, comprising a memory, a processor communicably coupled to the memory, the processor communicably coupled to the network, the processor adapted to identify a media access control address upon connection to the network, count a data packet generated per unit time by the media access control address on the network and block access of the media access control address to the network if the counted data packets exceeds a pre-defined threshold, wherein the blocking is active for a pre-set interval. In other embodiments the invention may comprise disinfecting the media access control address exceeding the pre-defined threshold.

### BRIEF DECOMPUTER PROGRAMION OF THE DRAWINGS

FIG. 1 depicts a method of preventing denial of service attacks in a network system in accordance with a preferred embodiment of the present invention; and

FIG. 2 depicts a software flow block in accordance with a preferred embodiment of the present invention.

### DETAILED DECOMPUTER PROGRAMION OF THE INVENTION

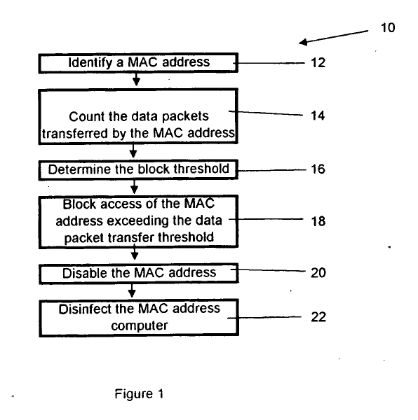

Referring now to FIG. 1, a method for preventing denial of service attacks in a network 10 is shown. The invention comprises identifying 12 an address, typically a MAC address. A number of data packets transferred by the address is counted 14. A threshold of denial of service is determined 16. If the number of data packets transferred exceeds the threshold, access to the network is blocked 18. If the number of data packets transferred exceeds the threshold the MAC address is disabled 20 and a computer associated with the MAC address is disinfected. In other embodiments, the counting may per performed per time unit, the blocking may be active for the pre-set interval, the address may be disabled, the address may be the media access control address, the counting could be performed at layer 2 or layer 1, the address may be identified upon connection to the network, the threshold may be based upon the number of computers utilizing the network, the defined threshold may be based upon a bandwidth of the network and the disinfecting may be done of the address exceeding the pre-defined threshold. The steps performed in this figure are performed by software, hardware, firmware, and/or the combination of software, hardware, and/or firmware. The transfer of information between the network and processor occurs via at least one of the wireless protocol, the wired protocol and the combination of the wireless protocol and the wired protocol.

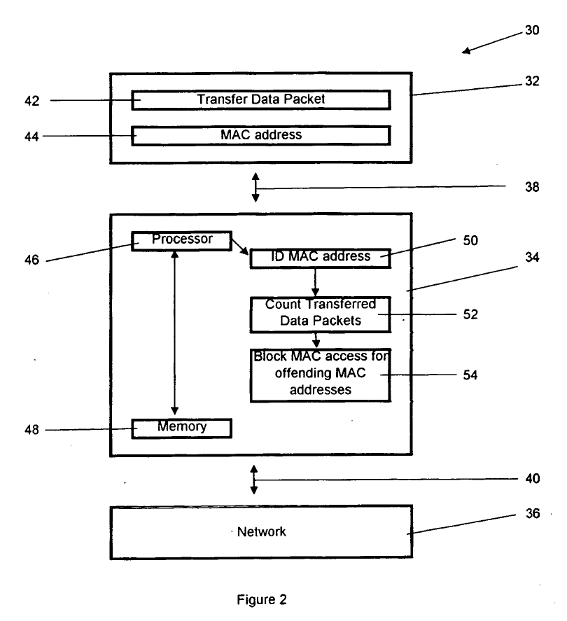

Referring now to FIG. 2 a system for preventing denial of service attacks in the network 30 is depicted and comprises the number of blocks or modules that are software, hardware, firmware, and/or the combination of software, hardware, and/or firmware. The system is adapted to provide preventing denial of service attacks in the network 36, comprising a memory 48, a processor 46 communicably coupled to the memory, the processor is communicably coupled 40 to the network 36. The processor is adapted to identify 50 the media access control address upon connection to the network, count 52 the data packet generated per unit time by the media access control address on the network and block 54 access of the media access control address to the network if the counted data packets exceeds the pre-defined threshold, wherein the blocking is active for the pre-set interval. In other embodiments the invention may comprise disinfecting the media access control address exceeding the pre-defined threshold. For example, the presence infrastructure may be accessed by the cellular phone or the computer with external wireless capability (such as the wireless card) or internal wireless capability (such as 802.11 or any of the other 802 variants), or by the Internet Protocol enabled phone. The communications coupling occurs via at least one of the-wireless protocol, the wired protocol and the combination of the wireless protocol and the wired protocol.

Although the exemplary embodiment of the system of the present invention has been illustrated in the accompanied drawings and described in the foregoing detailed computer program, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the processor, memory and network. Also, these capabilities may be performed in the current manner or in the distributed manner and on, or via, any device able to provide and/or receive data packets. Further, although depicted in the particular manner, various modules or blocks may be repositioned without departing from the scope of the current invention. For example, the functionality performed by the processor and memory may be self contained. Still further, although depicted in the particular manner, the greater or lesser number of data packets, MAC addresses, processors, memories and networks can be utilized with the present invention. Further, the lesser or greater number of data packets may be utilized with the present invention and such data packets may include known complementary information in order to accomplish the present invention, to provide additional known features to the present invention, and/or to make the present invention more efficient.

What is claimed is:

1. A method for preventing denial of service attacks in a network, comprising:
counting a data packet generated by an address on the network; and
blocking access to the network of the address if the counted data packets exceeds a pre-defined threshold.

2. The method of claim 1 wherein the counting is performed per time unit.

3. The method of claim 1 wherein the blocking is active for a pre-set interval.

4. The method of claim 1 comprising disabling the address.

5. The method of claim 1 wherein the address is a media access control address.

6. The method of claim 1 wherein the counting is performed at layer 2.

7. The method of claim 1 wherein the counting is performed at layer 1.

8. The method of claim 1 comprising identifying the address upon connection to the network.

9. The method of claim 1 comprising defining the threshold based upon a number of computers utilizing the network.

10. The method of claim 1 comprising defining the threshold based upon a bandwidth of the network.

11. The method of claim 1 comprising disinfecting the address exceeding the pre-defined threshold.

12. A computer readable medium comprising instructions for:
identifying a media access control address upon connection to a network;
counting a data packet generated per unit time by the media access control address on the network; and
blocking access of the media access control address to the network if the counted data packets exceeds a pre-defined threshold.

13. The computer readable medium of claim 12 wherein the blocking is active for a pre-set interval.

14. The computer readable medium of claim 12 comprising instructions for disabling the media access control address.

15. The computer readable medium of claim 12 wherein the counting is performed at layer 2.

16. The computer readable medium of claim 12 wherein the counting is performed at layer 1.

17. The computer readable medium of claim 12 comprising instructions for defining the threshold based upon the number of computers utilizing the network and the bandwidth of the network.

18. The computer readable medium of claim 12 comprising disinfecting the media access control address exceeding the pre-defined threshold.

19. A system adapted to provide preventing denial of service attacks in a network, comprising:
a memory; and
a processor communicably coupled to the memory, the processor communicably coupled to the network, the processor adapted to:
identify a media access control address upon connection to the network;
count a data packet generated per unit time by the media access control address on the network; and
block access of the media access control address to the network if the counted data packets exceeds a pre-defined threshold, wherein the blocking is active for a pre-set interval.

20. The system of claim 19 comprising disinfecting the media access control address exceeding the pre-defined threshold.
